(19) United States
(12) Patent Application Publication
(10) Pub. No.: US 2008/0178648 A1
(43) Pub. Date: Jul. 31, 2008

(54) Device for hands-free access to a vehicle, designed to unlock at least one door of said vehicle

(75) Inventors: Luc Jansseune, Venerque (NL); Alain Brillon, Villeneuve Tolosane (FR); Benoit Depont, Labarthe-Sur-Leze (FR)

Correspondence Address: YOUNG & THOMPSON, 209 Madison Street, Suite 500, ALEXANDRIA, VA, 22314, US

(73) Assignee: CONTINENTAL AUTOMOTIVE FRANCE, TOULOUSE (FR)

(21) Appl. No.: 12/010,788

(22) Filed: Jan. 30, 2008

(30) Foreign Application Priority Data
Jan. 30, 2007 (FR) 0700627

(51) Int. Cl. E05B 65/20

(52) U.S. Cl. 70/257

(57) ABSTRACT

A device for hands-free access to a vehicle (V) includes a portable remote control unit (1) and a central processing unit (2) installed in the vehicle, each integrating transmission element (1a, 3) making it possible to implement procedures for authorizing access to the vehicle (V), and a switch (8-11) integrated into the handle (P) of at least one door and designed to switch from a passive to an active state when a user makes access to the handle. The central processing unit (2) is programmed to control the supply of an actuator (13) for unlocking the door immediately after validation of an access authorization procedure, and the switch (8-11) is electrically integrated into the circuit (6) for supplying this actuator (13) so as to keep this supply circuit open in the passive state of the switch.

The invention relates to a device for hands-free access to a vehicle, designed to unlock at least one door of said vehicle.

The devices for hands-free access to a vehicle conventionally comprise a portable remote control unit, a central processing unit installed in the vehicle, and transmission means which, on the one hand, are arranged in said vehicle and, on the other hand, are integrated into said control unit and designed to allow a dialog to be established between the central processing unit and the control unit for the purpose of implementing procedures for authorizing access to the vehicle.

The current conventional hands-free access devices additionally comprise a switch designed to be imbedded in a door handle and to switch from a passive state to an active state when a user makes access to said handle so as, upon this activation, to initiate a procedure of identifying the control unit carried by the user and to unlock the door.

One of the drawbacks of these hands-free access devices results from the obligation to obtain an unlocking of the door before the complete actuation of the handle, failing which the closure mechanism of this door remains locked, prohibiting said door from opening.

Specifically, this obligation requires that use be made, as switches integrated into the handles, of highly reactive proximity sensors, such as, for example, capacitive sensors, which prove not only to have a relatively high cost price but also to be relatively sensitive to environmental conditions: rain, ice, earth or environmental magnetic field, etc.

Furthermore, notwithstanding the performance of current proximity sensors, the time assigned to perform the identification and unlocking operations frequently proves to be inadequate, with the result that the door does not unlock during the first operation of the handle (incident known as “wall effect”). It is necessary in that case to operate the handle a second time in order to open the door. This type of incident is generally poorly perceived by the user.

In order to overcome the drawback relating to the “wall effect”, one development consisted in producing hands-free access devices designed to allow an identification of the control unit as soon as they are introduced into a region, termed coverage region, of predetermined extent around the vehicles, and hence before the user touches or approaches the handle.

Accordingly, these hands-free access devices are programmed so as to implement an identification procedure consisting in controlling the periodic transmission by the central processing unit installed in the vehicle of a data frame incorporating a preamble consisting of a predefined wake code identifiable by the control unit, after identification of which said control unit is programmed to flip from a standby state to an active state allowing a dialog to be established with the central processing unit.

According to this concept, the identification procedure is thus performed before the activation of the switch integrated into the handle, with the result that this activation controls only the unlocking procedure and no longer the identification procedure.

However, it proves that the time required to carry out these locking procedures remains sufficiently long: processing of the information by the central processing unit of the hands-free access device, transmission of this information to the multiplexed network installed in the vehicle, processing of the information by the general central processing unit for managing the vehicle cabin, and actual operating time of the actuator.

For this reason, and in order to guarantee against the occurrence of any “wall effects”, all the current vehicles remain equipped with proximity sensors, this being in spite of the inherent drawbacks thereof, namely in particular their cost and their sensitivity.

The present invention is aimed at overcoming this drawback and has the main objective of providing hands-free access devices designed so that the time required to achieve the unlocking of a door, after activation of the switch integrated into the door handle, is optimally reduced, making it possible, without any risk of a “wall effect” occurring, to equip said handle with a simple switch which can be activated by a user's hand contact and no longer with an expensive proximity detector.

Accordingly, the invention is aimed at a device for hand-free access to a vehicle, designed to unlock at least one door of said vehicle provided with a handle and equipped with an unlocking/locking actuator and with a circuit for supplying said actuator; said hands-free access device comprising:
a portable remote control unit,
a central processing unit installed in the vehicle,
transmission means which, on the one hand, are arranged in the vehicle and, on the other hand, are integrated into the control unit and designed to allow a dialog to be established between the central processing unit and the control unit for the purpose of implementing procedures for authorizing access to the vehicle,
and a switch integrated into the handle of the door and designed to switch from a passive state to an active state when a user makes access to said handle,
   and said hands-free access device being designed to control the supply of the unlocking/locking actuator after validation of a procedure for authorizing access to the vehicle, and switching of the switch to its active state.

According to the invention, this hands-free access device is characterized in that:
the central processing unit is programmed to control the supply of the unlocking/locking actuator immediately after validation of a procedure for authorizing access to the vehicle,
and the switch is electrically integrated into the circuit for supplying the unlocking/locking actuator so as to keep this supply circuit open in the passive state of said switch and to close said supply circuit in its active state.

The principle of the invention is therefore to control the electrical supply of the unlocking/locking actuator immediately after identification of a control unit, and to initiate the actual operation of this actuator during the activation of the switch integrated into the door handle, which for this purpose is electrically connected in the circuit for supplying said actuator.

According to this principle, the time required to achieve the unlocking of a door, after activation of a switch integrated into the door handle, is optimally reduced since it merely amounts to the time required by the actuator to perform the unlocking.

This time in fact proves to be virtually independent of the reactivity of the switches such that the handles can be equipped, without any risk of a “wall effect” occurring, with a simple switch which can be activated by a user's hand contact:
having a significantly lower cost price than that of current proximity sensors,
having very little sensitivity to environmental conditions, ensuring very good operational reliability.

According to one advantageous embodiment of the invention, the circuit for supplying the unlocking/locking actuator comprises a relay connected between the switch and said unlocking/locking actuator.

The prime advantage of such a relay is that of electrically protecting the switch. Furthermore, it makes it possible to ensure complete unlocking even if the user releases the handle before the time required for the actuator to perform this unlocking operation has elapsed.

According to another advantageous embodiment of the invention, the circuit for supplying the unlocking/locking actuator comprises a flip-flop provided with two connection inputs and with one connection output;
a first connection input to which is delivered a control signal transmitted by the central processing unit,
a second connection input connected in series with a switch,
and a connection output connected to the unlocking/locking actuator.

Furthermore, the central processing unit is advantageously connected to the circuit for supplying the unlocking/locking actuator so as, on the one hand, to receive a closure signal during the switching of the switch to its active state and, on the other hand, to deliver a reinitializing signal destined for the flip-flop after a predetermined time interval following the reception of the closure signal.

These arrangements make it possible to manage the time for supplying electrical power to the actuator, and to ensure, in particular, a minimum supply time capable of allowing unlocking in any conditions (presence of ice, etc.).

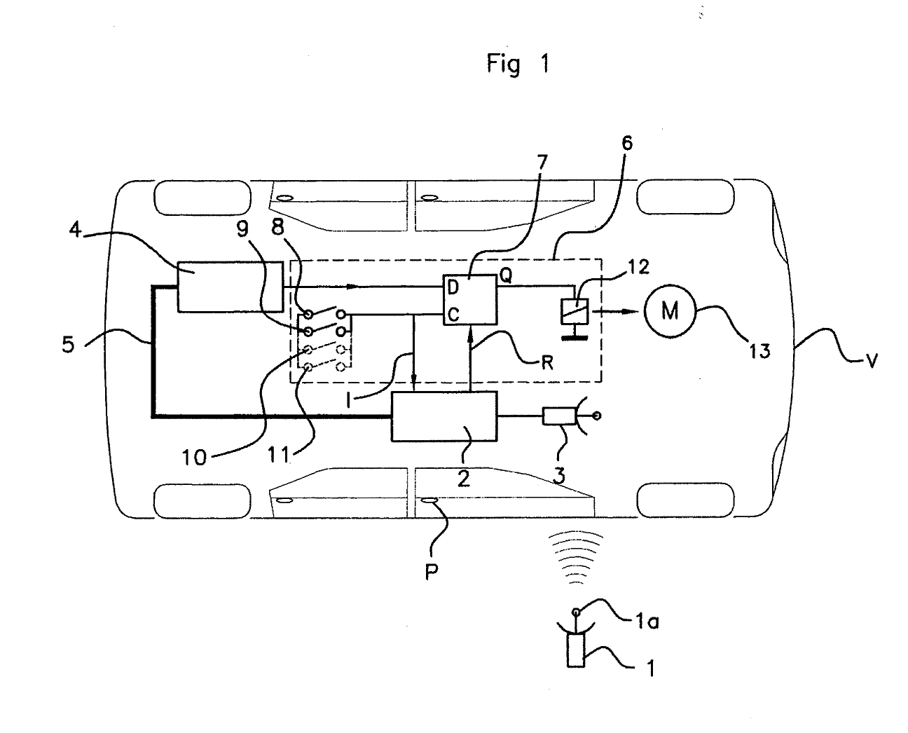

Other features, objects and advantages of the invention will become apparent from the detailed description which follows with reference to the appended drawing which represents a preferred embodiment thereof by way of nonlimiting example. In this drawing, the single FIG. 1 is a schematic plan view of a vehicle equipped with a hands-free access system according to the invention represented in the form of a functional block diagram.

The invention represented in FIG. 1 is aimed at a device customarily known as a “hands-free access device” designed to allow access to be gained to a vehicle V and, if appropriate, to start up the latter as a result of the identification of a portable remote control unit 1 commonly referred to as an “electronic badge”.

Firstly, this electronic badge 1 comprises a central unit incorporating a low frequency “LF” receiver and a radiofrequency “RF” transmitter which are connected to antennas such as 1a.

Apart from this electronic badge 1, the hands-free access device comprises, installed in the vehicle V and as represented in FIG. 1:
a specific central processing unit 2, termed hands-free processing unit, installed in the vehicle V and provided in particular with a low frequency “LF” transmitter and a radiofrequency “RF” receiver,
transmitting antennas such as 3 designed and arranged so as to delimit, around the vehicle V, a coverage region whose extent is defined by said antennas and the low frequency “LF” transmitter of the hands-free processing unit 2,
and switches 8-11 integrated into the handle P of each door, and there are thus four switches for the four-door vehicle V represented in FIG. 1.

In addition, the hands-free processing unit 2 of this hands-free access device is connected, by a multiplexed network 5, to a general central processing unit 4 for managing the vehicle cabin, termed cabin computer, which is designed in particular, in the context of the invention, to control a circuit 6 for supplying an unlocking/locking motor 13 of one of the doors of the vehicle V.

According to the invention, this supply circuit 6, inside which are electrically integrated the four switches 8-11 connected in parallel, comprises a “D” flip-flop 7 provided with two connection inputs D, C and with one connection output Q:
a first input D for receiving control signals delivered by the cabin computer 4,
a second clock input C connected in series with the switches 8-11,
and an outlet Q connected to a relay 12 for supplying the unlocking/locking motor 13.

Furthermore, the hands-free processing unit 2 is connected to the supply circuit 6 so as, on the one hand, to receive a closure signal I upon the closure of one of the switches 8-11 and, on the other hand, to deliver a reinitialization signal R destined for the flip-flop 7 after a predetermined time interval following the reception of the closure signal.

According to the principle of this hands-free access device, and firstly, the hands-free processing unit 2 is programmed to control the transmission by the cabin computer 4 of a signal for changing the state of the input D of the flip-flop 7, immediately after validation of a procedure for authorizing access to the vehicle V.

Furthermore, the subsequent actuation by the user of a handle P, confirming the intention to open the vehicle V, leads to the closure of one of the switches 8-11 and causes the change of state of the second input C of the flip-flop 7, and consequently the change of state of the output Q and the supplying of the relay 12 and the motor 13.

This closure additionally controls the transmission, destined for the hands-free processing unit 2, of the closure signal I for starting the time delay after which said hands-free computer is programmed to deliver a signal R for reinitializing the flip-flop 7.

According to the invention, the time required to achieve the unlocking of a door, after activation of one of the switches 8-11 integrated into the handles P of the doors, is optimally reduced since it merely amounts to the time required by the motor 13 to perform the unlocking.

By way of example, the average time required to achieve this unlocking according to the method of the invention is around 60 ms, whereas currently the minimum time required is around 150 ms.

1. A device for hand-free access to a vehicle (V), designed to unlock at least one door of said vehicle provided with a handle (P) and equipped with an unlocking/locking actuator (13) and with a circuit (6) for supplying said actuator;
said hands-free access device comprising:
a portable remote control unit (1),
a central processing unit (2) installed in the vehicle,
transmission means (1a, 3) which, on the one hand, are arranged in the vehicle (V) and, on the other hand, are integrated into the control unit (1) and designed to allow a dialog to be established between the central processing unit (2) and the control unit (1) for the purpose of implementing procedures for authorizing access to the vehicle (V),
and a switch (8-11) integrated into the handle (P) of the door and designed to switch from a passive state to an active state when a user makes access to said handle,
said hands-free access device being designed to control the supply of the unlocking/locking actuator (13) after validation of a procedure for authorizing access to the vehicle (V), and switching of the switch (8-11) to its active state, and said hands-free access device being characterized in that:
the central processing unit (2) is programmed to control the supply of the unlocking/locking actuator (13) immediately after validation of a procedure for authorizing access to the vehicle (V),
and the switch (8-11) is electrically integrated into the circuit (6) for supplying the unlocking/locking actuator (13) so as to keep this supply circuit (6) open in the passive state of said switch and to close said supply circuit in its active state.

2. The hands-free access device as claimed in claim 1, characterized in that the circuit (6) for supplying the unlocking/locking actuator (13) comprises a relay (12) connected between the switch (8-11) and said unlocking/locking actuator.

3. The hands-free access device as claimed in claim 1, characterized in that the circuit (6) for supplying the unlocking/locking actuator (13) comprises a flip-flop (7) provided with two connection inputs (D, C) and with one connection output (Q);
a first connection input (D) to which is delivered a control signal transmitted by the central processing unit (2),
a second connection input (C) connected in series with a switch (8-11),
and a connection output (Q) connected to the unlocking/locking actuator (13).

4. The hands-free access device as claimed in claim 3, characterized in that the central processing unit (2) is connected to the circuit (6) for supplying the unlocking/locking actuator (13) so as, on the one hand, to receive a closure signal (I) during the switching of the switch (8-11) to its active state and, on the other hand, to deliver a reinitializing signal (R) destined for the flip-flop (7) after a predetermined time interval following the reception of the closure signal.

5. The hands-free access device as claimed in claim 2, characterized in that the circuit (6) for supplying the unlocking/locking actuator (13) comprises a flip-flop (7) provided with two connection inputs (D, C) and with one connection output (Q);
a first connection input (D) to which is delivered a control signal transmitted by the central processing unit (2),
a second connection input (C) connected in series with a switch (8-11),
and a connection output (Q) connected to the unlocking/locking actuator (13).
